(19) United States
(12) Patent Application Publication
(10) Pub. No.: US 2019/0186890 A1
(43) Pub. Date: Jun. 20, 2019

(54) WORKPIECE MEASURING MACHINE, MEASURING METHOD AND CALIBRATION METHOD OF SECTIONAL DIFFERENCE OF CASING OF WORKPIECE

(71) Applicant: UTECHZONE CO., LTD., New Taipei City (TW)

(72) Inventors: Yung-Chieh Liang, New Taipei City (TW); Chi-Kang Chen, New Taipei City (TW)

(73) Assignee: UTECHZONE CO., LTD., New Taipei City (TW)

(21) Appl. No.: 15/921,673

(22) Filed: Mar. 15, 2018

(30) Foreign Application Priority Data
Dec. 20, 2017 (TW) 106144697

(51) Int. Cl. G01B 5/06

(52) U.S. Cl. CPC G01B 5/061

(57) ABSTRACT

A workpiece measuring machine adapted to measure a workpiece under test is provided. The workpiece under test includes an assembly surface and an appearance surface. The workpiece measuring machine includes a bearing base, a height measuring device and a calculation device. The bearing base is adapted to bear the workpiece under test. The height measuring device is movably disposed at a side of the bearing base and adapted to measure heights of the assembly surface and the appearance surface. The calculation device is electrically connected to the height measuring device so as to calculate a height difference between the assembly surface and the appearance surface. A measuring method and a calibration method of sectional difference of casing of workpiece are also provided.

### CROSS-REFERENCE TO RELATED APPLICATION

This application claims the priority benefit of Taiwan application serial no. 106144697, filed on Dec. 20, 2017. The entirety of the above-mentioned patent application is hereby incorporated by reference herein and made a part of this specification.

### BACKGROUND OF THE INVENTION

### 1. Field of the Invention

The invention relates to a workpiece measuring machine, and a measuring method and a calibration method of sectional difference of casing of workpiece.

### 2. Description of Related Art

In general, an external housing of an object is commonly formed by two casings. In an example where the two casings are respectively a main casing and a cover, the main casing may include an appearance surface and an assembly surface, a sectional difference is present between the appearance surface and the assembly surface, and the cover may be disposed to the assembly surface of the main casing. Accordingly, a profile of the assembled cover and appearance surface of the main casing is coherent. However, since the sectional differences between the appearance surface and the assembly surface of the main casing may differ at different regions, when the cover is assembled to the main casing, the surface of the cover may be higher or lower than the appearance surface. Thus, an overall appearance may be affected.

### SUMMARY OF THE INVENTION

One or some exemplary embodiments of the invention provide a workpiece measuring machine capable of measuring a distance between an assembly surface and an adjacent appearance surface of a workpiece under test for subsequent adjustment.

One or some exemplary embodiments of the invention provide a measuring method of sectional difference of casing of workpiece capable of measuring a sectional difference between an assembly surface and an adjacent appearance surface of a workpiece under test.

One or some exemplary embodiments of the invention provide a calibration method of sectional difference of casing of workpiece capable of adjusting the workpiece under test based on the measuring method of sectional difference of casing of workpiece.

A workpiece measuring machine according to an embodiment of the invention is adapted to measure a workpiece under test. The workpiece under test includes an assembly surface and an appearance surface surrounding the assembly surface. A sectional difference is present between the assembly surface and the appearance surface. The workpiece measuring machine includes a bearing base, a height measuring device, and a calculation device. The bearing base is adapted to bear the workpiece under test. The height measuring device is movably disposed at a side of the bearing base. In addition, the height measuring device is adapted to measure heights of the assembly surface and the appearance surface. The calculation device is electrically connected to the height measuring device to calculate a height difference between the assembly surface and the appearance surface.

A measuring method of sectional difference of casing of workpiece according to an embodiment of the invention includes: providing a workpiece under test including an assembly surface and an appearance surface surrounding the assembly surface, wherein a sectional difference is present between the assembly surface and the appearance surface; measuring height information of a plurality of first measuring points on the assembly surface and a plurality of second measuring points on the appearance surface, wherein the second measuring points respectively correspond to the first measuring points; and calculating whether a plurality of height differences between the first measuring points and the corresponding second measuring points are respectively within a predetermined range.

A calibration method of sectional difference of casing of workpiece according to an embodiment of the invention includes: the measuring method of sectional difference of casing of workpiece; and adjusting a height of the assembly surface near the first measuring point or a height of the appearance surface near the second measuring point when the height difference between each of the first measuring point and the corresponding second measuring point falls out of the predetermined range, such that the height difference between the first measuring point and the corresponding second measuring point after adjustment falls within the predetermined range.

Based on the above, in the measuring method of sectional difference of casing of workpiece according to the embodiments of the invention, the height measuring device is adapted to measure the heights of the assembly surface and the appearance surface of the workpiece under test, and the measurement information is transmitted to the calculation device to calculate the sectional differences between the assembly surface and the appearance surface and thereby determine whether the calculated sectional difference falls within the predetermined range. If the sectional differences fall out of the predetermined range, the calibration method of sectional difference of casing of workpiece according to the embodiments may be adopted to adjust the heights of the assembly surface and the appearance surface of the workpiece under test based on the calculated sectional differences and standard values, so as to fit the thickness of the cover. Hence, the workpiece with a desirable appearance quality is manufactured in a simple and convenient way.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view illustrating a workpiece under test and a cover.

FIG. 2 is a schematic perspective view illustrating an A-A cross-section of the workpiece under test of FIG. 1.

FIG. 3 is a schematic view illustrating a workpiece measuring machine according to an embodiment of the invention.

FIG. 4 is a schematic partially enlarged view illustrating the workpiece measuring machine of FIG. 3.

FIG. 5 is a schematic top view illustrating that the workpiece measuring machine of FIG. 3 measures a workpiece under test.

FIG. 6 is a flowchart illustrating a measuring method of sectional difference of casing of workpiece according to an embodiment of the invention.

FIG. 7 is a flowchart illustrating a calibration method of sectional difference of casing of workpiece according to an embodiment of the invention.

FIGS. 8 and 9 are schematic perspective views illustrating other workpiece under tests.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

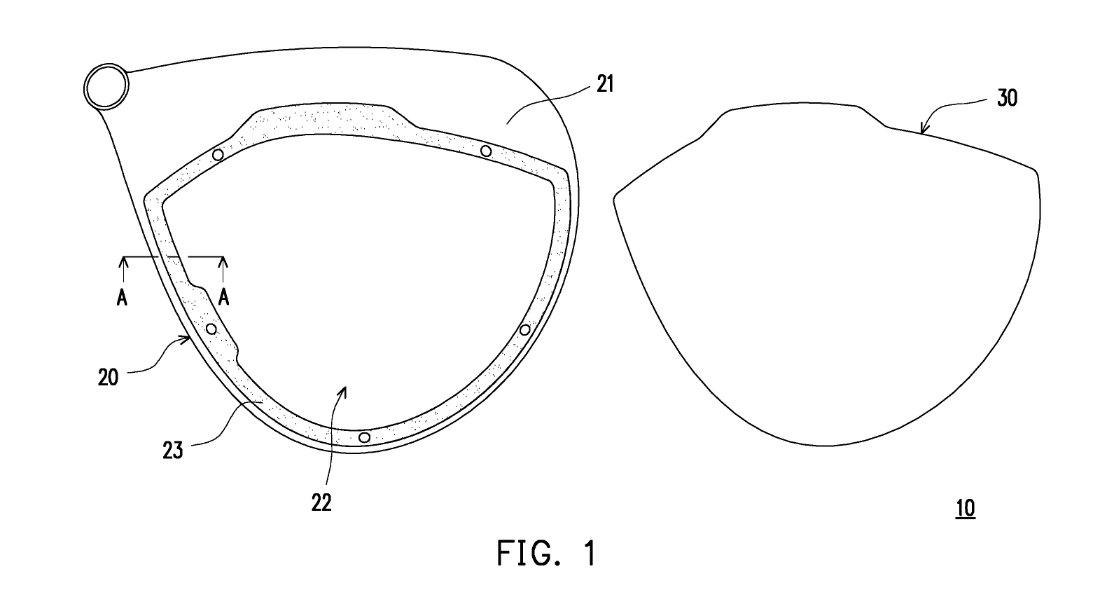

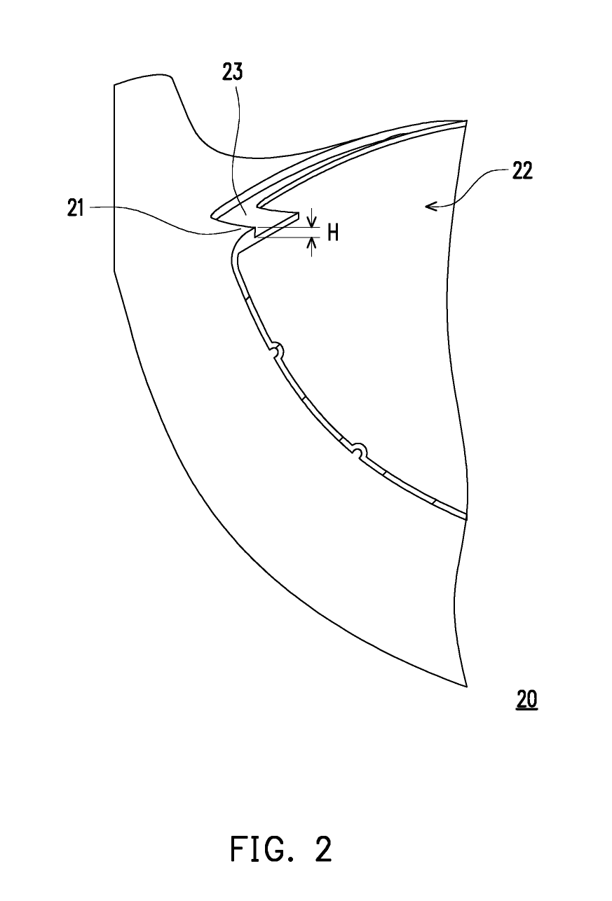

FIG. 1 is a schematic top view illustrating a workpiece under test and a cover. FIG. 2 is a schematic perspective view illustrating an A-A cross-section of the workpiece under test of FIG. 1. Referring to FIGS. 1 and 2, in the embodiment, a workpiece under test 20 is described as a golf club head main casing, for example. However, the type of the workpiece under test is not limited thereto. The workpiece under test 20 and a cover 30 may be assembled to form a workpiece product 10. In the embodiment, the workpiece product 10 is described as a golf club head, for example. However, the type of the workpiece product 10 is not limited thereto.

As shown in FIGS. 1 and 2, in the embodiment, the workpiece under test 20 is a hollow casing and has an opening 22. The workpiece under test 20 is provided with an assembly surface 23 adjacent to the opening 22. The cover 30 is fixed to the assembly surface 23 and covers the opening 22 to complete manufacture of the workpiece product 10. In general, the assembly surface 23 of the workpiece under test 20 is lower than the appearance surface 21, and a sectional difference H (shown in FIG. 2) between the assembly surface 23 and the appearance surface 21 is approximately equivalent to a thickness of the cover 30. Accordingly, after the cover 30 is assembled to the workpiece under test 20, a surface of the cover 30 and the appearance surface 21 of the workpiece under test 20 are expected to be at the same height at an interface, so as to keep the overall appearance coherent.

However, under some conditions, such as that the appearance of the workpiece under test 20 is in an irregular shape or that a precision level of a manufacturing process imposes a limitation, there may be a greater tolerance at sectional differences H (shown in FIG. 2) between the appearance surface 21 and the assembly surface 23. In addition, the sectional differences H between the appearance surface 21 and the assembly surface 23 may differ at different regions. Therefore, when the cover 30 is assembled to the workpiece under test 20, the surface of the cover 30 may be higher or lower than the appearance surface 21 and thus affect the overall appearance of the workpiece product 10. In such circumstance, the appearance of the workpiece product 10 may exhibit a discontinuous profile at the interface between the workpiece under test 20 and the cover 30. In the following, a workpiece measuring machine and a measuring method thereof are described. With the machine and the method, the sectional differences between the appearance surface 21 and the assembly surface 23 of the workpiece under test 20 at different regions may be reduced.

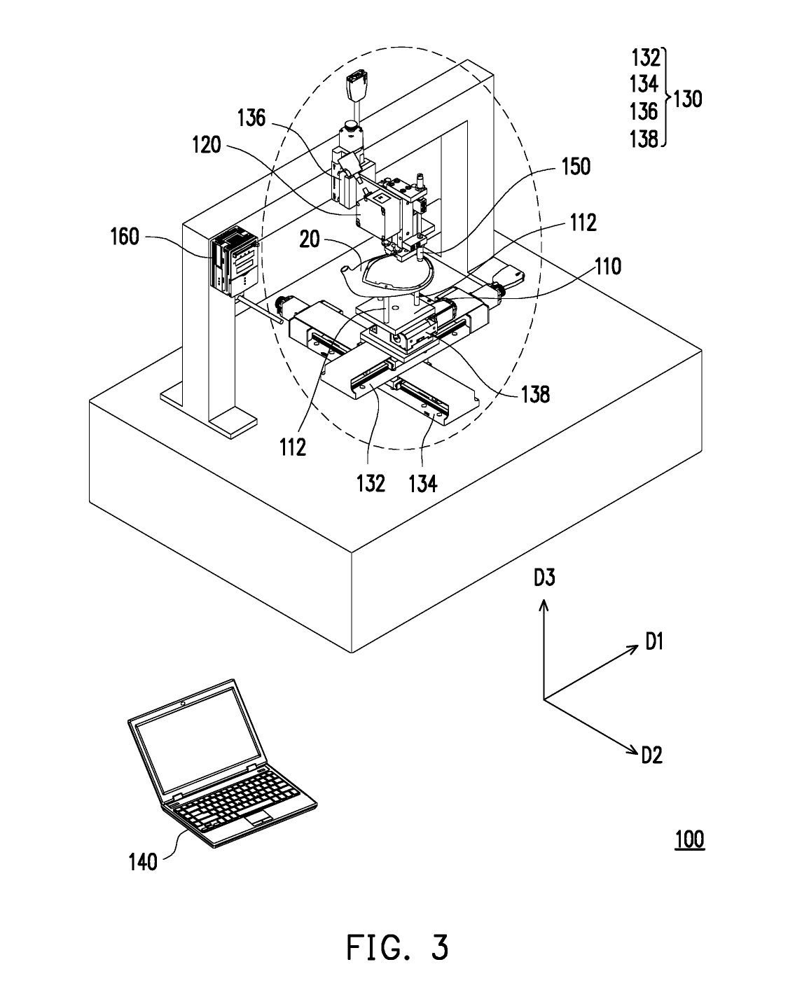

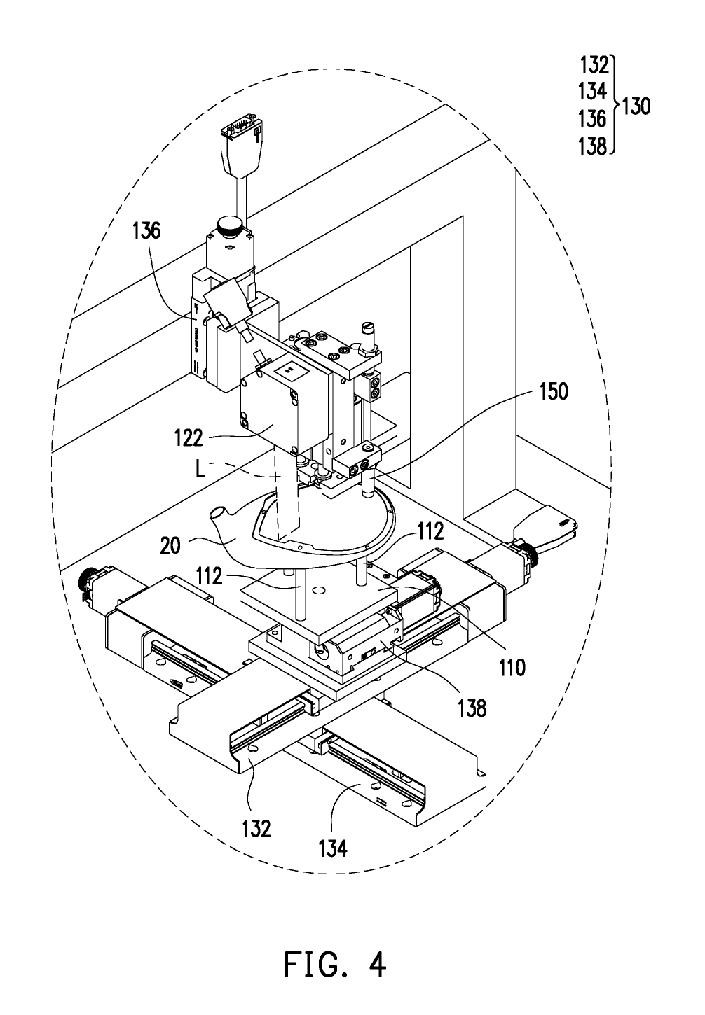

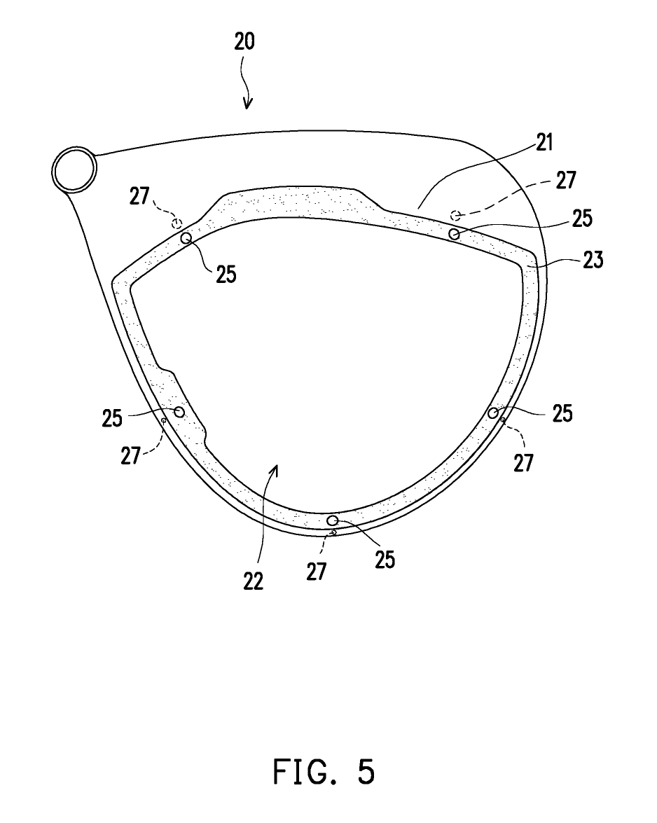

FIG. 3 is a schematic view illustrating a workpiece measuring machine according to an embodiment of the invention. FIG. 4 is a schematic partially enlarged view illustrating the workpiece measuring machine of FIG. 3. FIG. 5 is a schematic top view illustrating that the workpiece measuring machine of FIG. 3 measures a workpiece under test. As shown in FIG. 5, a measuring point is further marked at the workpiece under test 20, so as to schematically show which part of the workpiece under test 20 is measured by a workpiece measuring machine 100 of FIG. 3.

Referring to FIGS. 3 to 5, the workpiece measuring machine 100 of the embodiment is adapted to measure a height at a specific position of the workpiece under test 20. As shown in FIG. 5, the workpiece under test 20 includes the assembly surface 23 and the appearance surface 21. The assembly surface 23 is a surface contacting the cover 30 when the cover 30 is assembled to the workpiece under test 20. When the cover 30 is assembled to the workpiece under test 20, the opening 22 of the workpiece under test 20 may be shielded by the cover 30, and the workpiece under test 20 and the cover 30 are assembled to form the workpiece product 10 (shown in FIG. 1). The appearance surface 21 is a surface not shielded by the cover 30 but is exposed after the cover 30 is assembled to the workpiece under test 20.

In the embodiment, the workpiece measuring machine 100 may obtain sectional information of the assembly surface 23 and the appearance surface 21 of the workpiece under test 21 before the cover 30 is assembled to the workpiece under test 20 to determine whether the sectional differences H between the assembly surface 23 and the appearance surface 21 at different regions may be excessively great or small. Then, based on values obtained, the manufacturer may adjust the sectional difference H between the assembly surface 23 and the appearance surface 21 through, for example, polishing the assembly surface 23 or the appearance surface 21 of the workpiece under test 20, so that the adjusted sectional difference may meet the needs.

Accordingly, in a subsequent assembling process, after the cover 30 is assembled to the workpiece under test 20, the surface of the cover 30 and the appearance surface 21 of the workpiece under test may 20 may fit each other well. Thus, in a manufacturing process of the workpiece product 10, the workpiece measuring machine 100 may automatically carry out measurement to manufacture the workpiece product 10 with a desirable appearance quality in a simple and convenient way. In the following, the workpiece measuring machine 100 is described in detail.

As shown in FIGS. 3 and 4, the workpiece measuring machine 100 includes a bearing base 110, a height measuring device 120, a motion device 130, and a calculation device 140. The bearing base 110 is adapted to bear the workpiece under test 20. Due to the irregular shape of the workpiece under test 20, in order to stably support the workpiece under test 20, the bearing base 110 of the embodiment provides a plurality of columns 112. The workpiece under test 20 is adapted to be disposed on the columns 112 to be maintained at a specific angle.

In the embodiment, the columns 112 may have different heights. For example, the columns 112 may be designed to have different heights in correspondence with variations of the profile of the workpiece under test 20. The columns 112 may be distributed irregularly in correspondence with the profile of the workpiece under test 20. Of course, the shapes, heights, number, and disposed positions of the columns 112 are not limited to those in the embodiment. Besides, in other embodiments, the bearing case 110 may also be arranged in a different form, and is not limited to the form shown in the embodiment.

As shown in FIG. 3, the height measuring device 120 is disposed at a side of the bearing base 110, and is adapted to measure heights of the assembly surface 23 (shown in FIG. 5) and the appearance surface 21 (shown in FIG. 5) of the workpiece under test 20. In the embodiment, the height measuring device 120 is disposed above the bearing base 110. However, the position of the height measuring device 120 is not limited thereto. The height measuring device 120 may, for example, optically measure height information of first measuring points 25 on the assembly surface 23 and corresponding second measuring points 27 of the appearance surface 21. While FIG. 4 only schematically illustrates a light beam L, the height measuring device 120 may project a light beam or detect a variation of a light beam, and a position irradiated by the light beam L is not limited to the illustration of FIG. 4.

Of course, in other embodiments, the height measuring device 120 may also obtain the height information by mechanically moving from a reference point to the first measuring points 25 on the assembly surface 23 and the corresponding second measuring points 27 on the appearance surface 21. How the height measuring device 120 measures height positions of the first measuring points 25 on the assembly surface 23 and the corresponding second measuring points 27 on the appearance surface 21 is not limited to those described above.

In the workpiece measuring machine 100 of the embodiment, by connecting the motion device 130 to at least one of the bearing base 110 and the height measuring device 120, a position of the bearing base 110 relative to the height measuring device 120 may be adjustable. Accordingly, the height measuring device 120 is able to measure the first measuring points 25 on the assembly surface 23 of the workpiece under test 20 on the bearing base 110 and the second measuring points 27 corresponding to the first measuring points 25 on the appearance surface 21, so as to more thoroughly measure the sectional differences H between the assembly surface 23 and the appearance surface 21 of the workpiece under test 20 at different sections and thereby facilitate a precision level of subsequent calibration.

Specifically, in the embodiment, the motion device 130 includes a first movement module 132, a second movement module 134, and a third movement module 136 whose movement directions are perpendicular to each other. The bearing base 110 is disposed on the first movement module 132, the first movement module 132 is disposed on the second movement module 134, and the height measuring device 120 is disposed at the third movement module 136. Of course, positions where the first movement module 132, the second movement module 134, and the third movement module 136 are disposed are not limited to those described above.

In the embodiment, the first movement module 132, the second movement module 134, and the third movement module 136 may respectively move along the first direction D1, the second direction D2, and the third direction D3, so that the bearing base 110 may be adjusted to a position suitable for the height measuring device 120 to carry out measurement. Besides, in the embodiment, the motion device 130 further includes a rotating module 138 connected to the bearing base 110. Accordingly, the bearing base 110 may rotate relative to the height measuring device 120. As shown in FIG. 4, the rotating module 138 is located between the bearing base 110 and the first movement module 132. However, a position at which the rotating module 138 is arranged is not limited thereto. Through operation of the motion device 130, the height measuring device 120 may move relative to the bearing base 110. Accordingly, the height measuring device 120 may measure the five first measuring points 25 and the five second measuring points 27 (shown in FIG. 5) of the workpiece under test 20 and obtain the height information of these positions.

Even though the height measuring device 120 of the embodiment is described to measure the five first measuring points 25 and the five second measuring points 27 as an example, the numbers and positions of the first measuring points 25 and the second measuring points 27 on the workpiece under test 20 are not limited thereto. In other words, numbers and positions of the measurement carried out by the height measuring device 120 on the workpiece under test 20 are not limited to those described in the embodiment. In the embodiment, the first measuring points 25 on the assembly surface 23 and the second measuring points 27 on the appearance surface 21 are set at equidistant positions on the assembly surface 23 and the appearance surface 21, for example. In other words, the height measuring device 120 may measure height values at positions with equal intervals on the assembly surface 23 and the appearance surface 21.

Besides, in the embodiment, the calculation device 140 may store a motion path corresponding to location information of the first measuring points 25 and the second measuring points 27. After the operator places the workpiece under test 25 on the bearing base 110 and starts the workpiece measuring machine 100, the calculation device 140 may instruct the motion device 130 to move along the motion path as planned, so that the height measuring device 120 may measure and obtain the height information as desired. Of course, in other embodiments, the height measuring device 120 may also move relative to the workpiece under test 20 manually or by other means.

After the calculation device 140 receives the height information of the first measuring points 25 on the assembly surface 23 and the second measuring points 27 on the appearance surface 21, the calculation device 140 may calculate the sectional differences H (i.e., height differences) between the assembly surface 23 and the appearance surface 21 at the positions of the measuring points. Besides, the calculation device 140 may further make comparison to determine whether the sectional differences H at the different positions are within a predetermined range.

Since different sections of the assembly surface 23 and the appearance surface 21 of the workpiece under test 20 may have different sectional differences H, if the whole assembly surface 23 is polished based on sectional difference information at one of the positions, there may be a greater error. In the embodiment, the height measuring device 120 may measure the sectional differences H between the assembly surface 23 and the appearance surface 21 of the workpiece under test 20 at different sections, and polish the assembly surface 23 based on the sectional information, so as to facilitate a precision level of calibrating the sectional difference of the workpiece under test 20.

For example, if the thickness of the cover 30 is in a range from about 0.95 millimeters to 1.05 millimeters, the predetermined sectional difference range of the workpiece under test 20 may correspond to the thickness of the cover 30 and range from about 0.95 millimeters to 1.05 millimeters. If the sectional differences calculated by the calculation device 140 fall out of the range from 0.95 millimeters to 1.05 millimeters, there may be a height difference at the interface between the workpiece under test 20 and the cover 30 after the cover 30 is subsequently assembled to the workpiece under test 20, and the appearance may be less coherent. Therefore, the calculation device 140 may record such information (e.g., a position where the actual sectional difference is inconsistent with the predetermined sectional difference and a difference therebetween). Accordingly, a manufacturer may modify the workpiece under test 20 based on such information (e.g., polishing the assembly surface 23, such that the actual sectional difference after polishing falls within the range of the predetermined sectional difference) subsequently.

Besides, in the embodiment, the workpiece measuring machine 100 further includes a marking device 150 electrically connected with the calculation device 140. When the sectional difference between the assembly surface 23 and the appearance surface 21 falls out of the predetermined range, the calculation device 140 may instruct the marking device 150 to leave an identification mark on the assembly surface 23. The marking device 150 may leave the identification mark at a specific position by laser or printing, so that the manufacturer may easily determine which position of the workpiece under test 20 requires modification afterwards. Besides, based on sizes of the differences between the actual sectional differences and the predetermined sectional difference, the calculation device 140 may instruct the marking device 150 to leave different identification marks on the assembly surface 23. For example, the identification marks may include sizes, colors, or patterns in different shapes. Alternatively, the identification marks may also be numbers or letters. Accordingly, the manufacturer may determine extents of modification based on the identification marks.

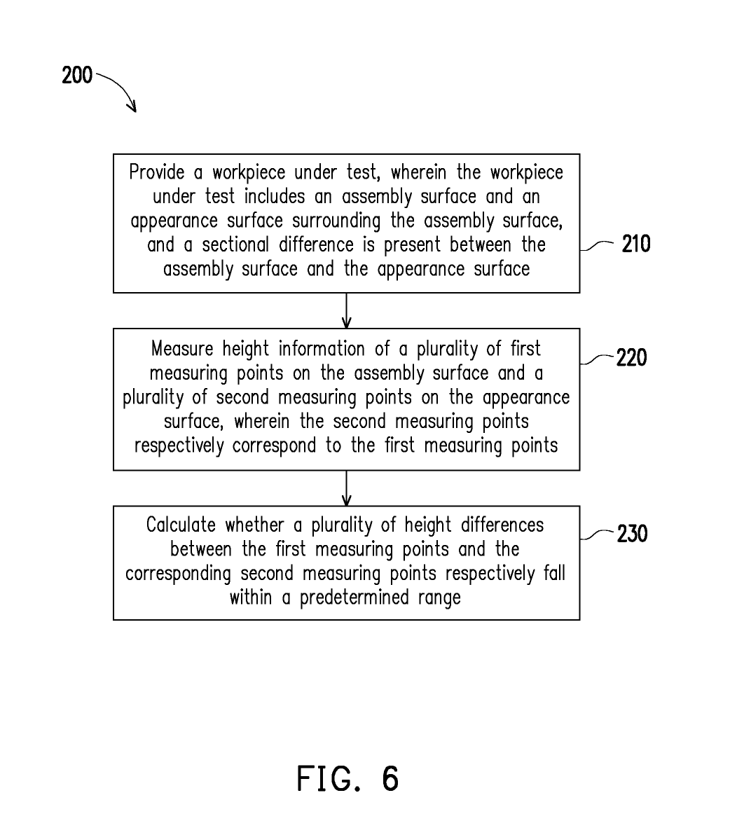

In the following, a measuring method 200 and a calibration method 300 of a sectional difference of a workpiece under test (i.e. a golf club head casing) applicable for the workpiece measuring machine 100 are described. FIG. 6 is a flowchart illustrating a measuring method of sectional difference of casing of workpiece according to an embodiment of the invention. Referring to FIG. 6, the measuring method 200 of sectional difference of casing of workpiece includes steps as follows.

First of all, referring to FIGS. 2, 5, and 6, the workpiece under test 20 is provided at Step 210. The workpiece under test 20 includes the opening 22 and the assembly surface 23 surrounding the opening 22 and the appearance surface 21 surrounding the assembly surface 23. In addition, the sectional difference H (shown in FIG. 2) is present between the assembly surface 23 and the appearance surface 21.

Then, at Step 220, the height information of the first measuring points 25 on the assembly surface 23 and the second measuring points 27 on the appearance surface 21 is obtained. The positions of the second measuring points 27 respectively correspond to the positions of the first measuring points 25. In the embodiment, Step 220 may further include, for example, moving or rotating the workpiece under test 20 relative to the height measuring device 120 (shown in FIG. 2), so that the height measuring device 120 may measure different positions on the assembly surface 23 and the appearance surface 21.

Then, at Step S230, whether a plurality of height differences between the first measuring points 25 and the corresponding second measuring points 27 are respectively within the predetermined range. As an example, the predetermined range may be from 0.95 millimeters to 1.05 millimeters. However, the invention is not limited thereto. It should be noted that the predetermined range may also be obtained from a standard sample of the workpiece under test 20. The operator may firstly measure the height differences between the first measuring points 25 and the corresponding second measuring points 27 on the standard sample to serve as the predetermined range of the height differences at Step 230.

Accordingly, whether the sectional differences between the assembly surface 23 and the appearance surface 21 of the workpiece under test 20 at different positions meet the needs may be determined. If the sectional differences meet the needs, the profile at the interface between the cover 30 and the workpiece under test 20 is coherent when the cover 30 is subsequently assembled to the workpiece under test 20, and the overall appearance is desirable.

If differences between respective first heights and corresponding second heights are not within the predetermined range, the surface of the cover 30 may be higher or lower than the appearance surface 21 of the workpiece under test 20, thus resulting an incoherent interface, after the cover 30 is subsequently assembled to the workpiece under test 20. Under the circumstance, the following calibration method 300 of the sectional differences of the casing of the workpiece may be applied to modify the sectional difference between the assembly surface 23 and the appearance surface 21 of the workpiece under test 20 at a specific position, so that the appearance may be more desirable after the cover 30 is assembled to the workpiece under test 20 subsequently.

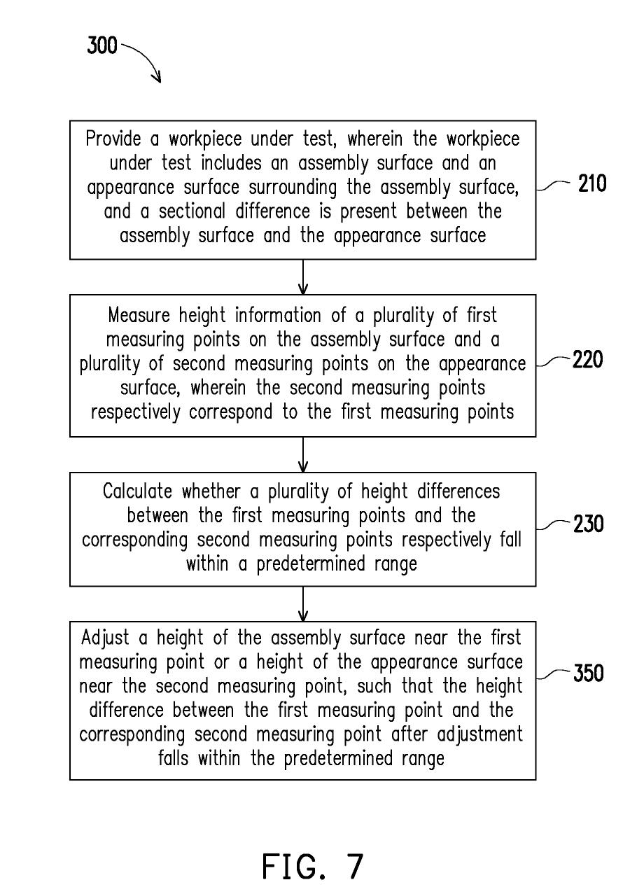

FIG. 7 is a flowchart illustrating a calibration method of sectional difference of casing of workpiece according to an embodiment of the invention. Referring to FIG. 7, in the calibration method 300 of the sectional differences of the casing of the workpiece of FIG. 7, details of Steps 210 to 230 may be referred to the descriptions of FIG. 6 and will not be repeated in the following. After Step 230, a step may be subsequently carried out to leave the identification mark at where the height difference is not within the predetermined range on the assembly surface 23 or the appearance surface 21. Leaving the identification mark may include, for example, leaving the identification mark at a specific position by laser or printing. Accordingly, the manufacturer may easily determine which position requires modification subsequently.

Besides, leaving the identification mark may further include instructing the marking device 150 to leave different identification marks on the assembly surface 23 or the appearance surface 21 based on the sizes of the differences between the actual sectional differences on the workpiece under test 20 and the predetermined sectional difference. For example, the identification marks may include sizes, colors, or patterns in different shapes. Alternatively, the identification marks may also be numbers or letters. Accordingly, the manufacturer may determine extents of modification based on the identification marks.

Then, at Step 350, the height of the assembly surface 23 near the first measuring point 25 or the height of the appearance surface 21 near the second measuring point 27 is adjusted. Accordingly, the height difference between the first measuring point 25 and the corresponding second measuring point 27 after the adjustment is within the predetermined range.

In the embodiment, if the actual sectional difference H is excessively small, a portion of the assembly surface 23 near the first measuring point 25 in a height direction may be removed (by polishing, for example) to increase the height difference between the first measuring point 25 and the corresponding second measuring point 27 at the position and keep the sectional difference H after the adjustment within the predetermined range. In the embodiment, if the actual sectional difference H is excessively great, a portion of the appearance surface 21 near the second measuring point 27 in the height direction may be removed (by polishing, for example), so as to reduce the height difference between the first measuring point 25 and the corresponding second measuring point 27 at the position and keep the sectional difference H after the adjustment within the predetermined range.

In the embodiment, the identification mark may be removed after the assembly surface 23 or the appearance surface is polished, so the appearance is not affected. Besides, means adopted to remove the portion of the assembly surface 23 or the appearance surface 21 is not limited to polishing. In other embodiments, the height may be reduced through chemical etching, for example, or other means.

Besides, in other embodiments, the sectional difference H may be adjusted by increasing the height. For example, if the actual sectional difference H is excessively great, a padding block (not shown) may be attached to the portion of the assembly surface 23 near the first measuring point 25, for example, to increase the height. In such case, the height difference between the first measuring point 25 and the corresponding second measuring point 27 at the position is also reduced, and the sectional difference H after the adjustment is kept within the predetermined range. The above only describes some enforceable aspects and has no intention to impose a limitation on this regard. Moreover, in other embodiments, Step 350 may be directly carried out after Step 230. In other words, the calibration can still be made if the step of the identification mark is omitted.

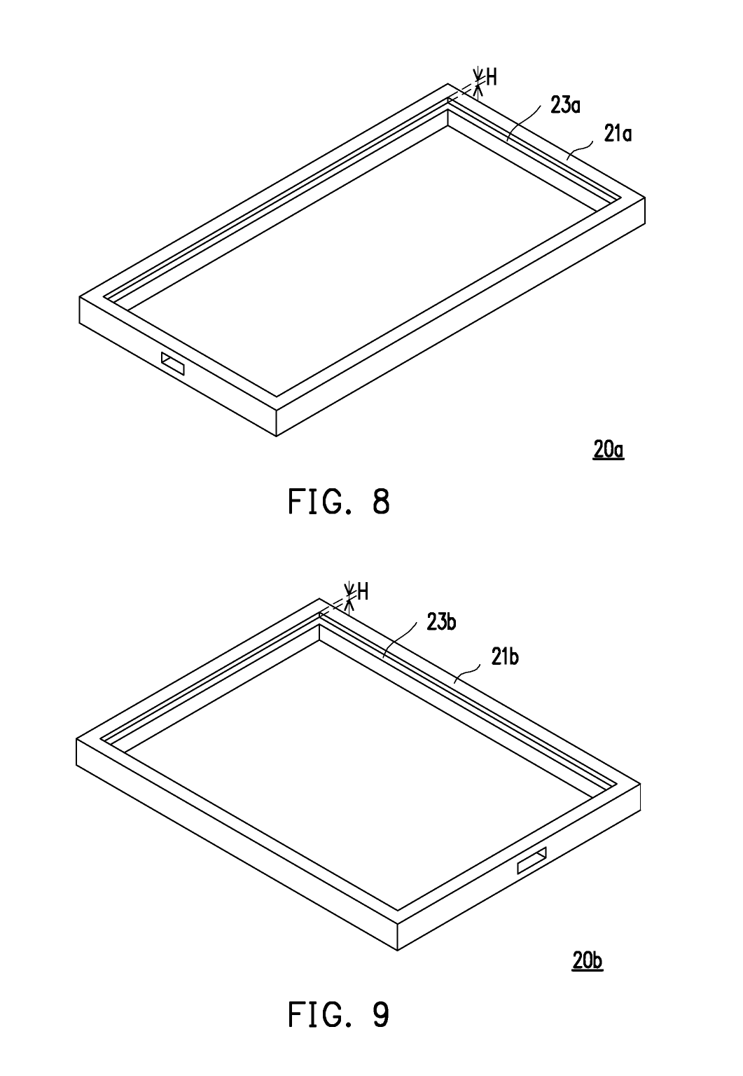

Even though the workpiece under test 20 is described as a golf club head main casing as an example in the above embodiments, the type of the workpiece under test 20 is not limited thereto. FIGS. 8 and 9 are schematic perspective views illustrating other workpiece under tests. FIGS. 8 and 9 only schematically illustrate workpiece under tests 20a and 20b, and parts or elements disposed in the workpiece under tests 20a and 20b are omitted.

Referring to FIG. 8, in the embodiment, the workpiece under test 20a may also be a main casing of a mobile phone adapted for a mobile phone back cover (not shown) to be fixed onto the main casing. The workpiece measuring machine 100 may similarly measure the sectional differences H between an assembly surface 21a and an appearance surface 23a at different positions of the workpiece under test 20a to ensure the appearance quality. Referring to FIG. 9, in the embodiment, the workpiece under test 20b may also be a main casing of a tablet computer adapted for a tablet computer back cover (not shown) to be fixed onto the main casing. The workpiece measuring machine 100 may similarly measure the sectional differences H between an assembly surface 21b and an appearance surface 23b at different positions of the workpiece under test 20b to ensure the appearance quality.

In view of the foregoing, in the measuring method of sectional difference of casing of workpiece according to the embodiments of the invention, the height measuring device of the workpiece measuring machine is adapted to measure the heights of the assembly surface and the appearance surface of the workpiece under test, and the measurement information is transmitted to the calculation device to calculate the sectional differences between the assembly surface and the appearance surface and thereby determine whether the calculated sectional difference falls within the predetermined range. During the measurement, the height measuring device may adjust a relative position with respect to the bearing base of the workpiece measuring machine to measure the sectional differences between the assembly surface and the appearance surface of the workpiece under test at different regions. When the sectional difference between the assembly surface and the appearance surface falls out of the predetermined range, the calibration method of sectional difference of casing of workpiece according to the embodiments of the invention may be adopted to adjust the heights of the assembly surface and the appearance surface of the workpiece under test based on the difference between the calculated sectional difference and the predetermined sectional difference by, for example, removing an excessive portion through polishing. Accordingly, the appearance profile may be smooth and coherent after the workpiece under test and the cover fit and fixed to each other. Hence, the workpiece with a desirable appearance quality is manufactured in a simple and convenient way.

Compared with manually touching the workpiece to inspect whether the profile is normal after the workpiece is assembled, the measuring method of sectional difference of casing of workpiece according to the embodiments of the invention is able to test quickly and accurately. Therefore, the testing efficiency is effectively facilitated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A workpiece measuring machine, adapted to measure a workpiece under test, wherein the workpiece under test comprises an assembly surface and an appearance surface surrounding the assembly surface, a sectional difference is present between the assembly surface and the appearance surface, and the workpiece measuring machine comprises:
a bearing base, adapted to bear the workpiece under test;
a height measuring device, movably disposed at a side of the bearing base, and adapted to measure heights of the assembly surface and the appearance surface; and
a calculation device, electrically connected to the height measuring device to calculate a height difference between the assembly surface and the appearance surface.

2. The workpiece measuring machine as claimed in claim 1, further comprising:
a marking device, electrically connected to the calculation device, wherein when the height difference between the assembly surface and the appearance surface falls out of a predetermined range, the calculation device instructs the marking device to leave an identification mark on the assembly surface, and the sectional difference is within a range from 0.95 millimeters to 1.05 millimeters.

3. The workpiece measuring machine as claimed in claim 1, further comprising:
a first movement module; and
a second movement module, wherein a motion direction of the second movement module is perpendicular to a motion direction of the first movement module, the bearing base is disposed on the first movement module, and the first movement module is disposed on the second movement module.

4. The workpiece measuring machine as claimed in claim 3, further comprising:
a third movement module, wherein a motion direction of the third movement module is perpendicular to the motion directions of the first movement module and the second movement module, and the height measuring device is disposed to the third movement module.

5. The workpiece measuring machine as claimed in claim 1, further comprising:
a rotating module, connected to the bearing base, such that the bearing base is rotatable relative to the height measuring device.

6. A measuring method of sectional difference of casing of workpiece, comprising:
providing a workpiece under test comprising an assembly surface and an appearance surface surrounding the assembly surface, wherein a sectional difference is present between the assembly surface and the appearance surface;
measuring height information of a plurality of first measuring points on the assembly surface and a plurality of second measuring points on the appearance surface, wherein the second measuring points respectively correspond to the first measuring points; and
calculating whether a plurality of height differences between the first measuring points and the corresponding second measuring points are respectively within a predetermined range.

7. The measuring method as claimed in claim 6, wherein measuring the height information of the first measuring points on the assembly surface and the second measuring points on the appearance surface further comprises:
moving or rotating the workpiece under test relative to a height measuring device for the height measuring device to measure different positions on the assembly surface and the appearance surface.

8. The measuring method as claimed in claim 7, wherein measuring the height information of the first measuring points on the assembly surface and the second measuring points on the appearance surface further comprises:
instructing a movement device linked to at least one of the workpiece under test and the height measuring device to operate based on to-be-tested location information.

9. A calibration method of sectional difference of casing of workpiece, comprising:
the measuring method of sectional difference of casing of workpiece according to claim 6, wherein the predetermined range is from 0.95 millimeters to 1.05 millimeters; and
adjusting a height of the assembly surface near the first measuring point or a height of the appearance surface near the second measuring point when the height difference between the first measuring point and the corresponding second measuring point falls out of the predetermined range, such that the height difference between the first measuring point and the corresponding second measuring point after adjustment falls within the predetermined range.

10. The calibration method as claimed in claim 9, wherein before adjusting the height of the assembly surface near the first measuring point or the height of the appearance surface near the second measuring point, the calibration method further comprises:
leaving an identification mark at a portion on the assembly surface or the appearance surface corresponding to the height difference falling out of the predetermined range; and
polishing the portion having the identification mark on the assembly surface or the appearance surface.
